(19) United States
(12) Patent Application Publication
(10) Pub. No.: US 2019/0065701 A1
(43) Pub. Date: Feb. 28, 2019

(54) System to enable copying of data from a digitally protected file without compromising security of the content

(71) Applicant: Seclore Technology Private Limited, Mumbai (IN)

(72) Inventors: Darshan Yadav, MUMBAI (IN); Kapil Dhaimade, MUMBAI (IN)

(73) Assignee: Seclore Technology Private Limited, Mumbai (IN)

(21) Appl. No.: 15/815,237

(22) Filed: Nov. 16, 2017

(30) Foreign Application Priority Data
Aug. 23, 2017 (IN) 201721029825

(51) Int. Cl. G06F 21/10; G06F 21/60; G06F 21/62

(52) U.S. Cl. CPC G06F 21/10; G06F 2221/0735; G06F 21/6209; G06F 21/602

(57) ABSTRACT

A system is described that allows for the transfer of data from a protected source file into a destination file that has the same or higher level of security than the source file, such that the security of the data is not compromised. Also described is a digital rights management system, capable of comparing the security levels on the source and destination files, and accordingly, allows or disallows the copying of content from the source file to the destination file.

### CROSS-REFERENCE TO RELATED APPLICATION

The instant application claims priority to Indian Patent Application Serial No. 201721029825, filed Aug. 23, 2017, pending, the entire specification of which is expressly incorporated herein by reference.

### FIELD OF THE INVENTION

The present invention relates to a system that allows copying of data from a digitally protected file without compromising the security of the content which was allowed to be copied.

### Definitions

As used in the present disclosure, the following terms are generally intended to have the meaning as set forth below, except to the extent that the context in which they are used, indicate otherwise.

The expression “Digital Right Management technology,” abbreviated as DRM, as used herein in this specification refers to, but is not limited to, an information rights management technology, designed to provide high levels of data security.

The expression “IDataObject interface,” as used herein in this specification refers to, but is not limited to, an interface that enables data transfer between applications.

The expression “source file,” as used herein in this specification refers to, but is not limited to, the digitally protected file from which data is to be copied.

The expression “destination file,” as used herein in this specification refers to, but is not limited to, a file in which the data copied from the source file is to be pasted.

### BACKGROUND OF THE INVENTION

Protecting confidentiality of sensitive data transferred between owner of any document/file, with the intended individual users or corporate teams is a necessity in this day and age. Many different solutions exist for protecting data and restricting its proliferation only to the intended users, including DRM. Generally, copying of data from a source file is prevented in a DRM protected document. But, in many cases, business needs dictate that data must be copied from a source file to a destination file. Thus, there is a need for a system that will allow for copying of data from a digitally protected file, without compromising the security of the data or content which is being copied. Existing systems of DRM adhere to one of two extreme alternatives—either they block all copying of data from the protected file or they freely allow copying of data from a protected file and pasting of the data into an unprotected file, hence nullifying the security imposed by the digital protection. The present invention overcomes these drawbacks of current systems of DRM, by providing a system that checks the permissions on the source and destination files and accordingly allows or disallows copying of the protected data in the source file.

### OBJECTS OF THE INVENTION

The object of the present disclosure is aimed at ameliorating one or more problems of the prior art or to at least provide useful alternatives.

An object of the present invention is to provide a system that allows for the copying of data from a digitally protected source file to a destination file which has similar or higher level of digital protection.

### SUMMARY OF THE INVENTION

The present invention provides a system that allows copying of data from a digitally protected source file to a destination file that has the same or higher level of digital protection. The system checks the permissions on the source and destination files and controls the copying of the data from the source file in such a way that it can only be pasted into a destination file that has equal or higher digital protection than the source file.

When a user attempts to copy data from a digitally protected file to the system clipboard, this message is intercepted by a DRM system. The DRM system encrypts the data and stores it on the system clipboard; the data is however stored in a custom registered format. Simultaneously, it also copies a standard message to the system clipboard, the message stating that the user does not have the permission to copy this data. Depending on the level of protection of the destination file, either the data is decrypted and pasted or the standard message is displayed.

### BRIEF DESCRIPTION OF THE DRAWINGS

FIG. 1 is a general overview of the components involved in the implementation of the present invention.

FIG. 2 depicts the system clipboard when data from a secure file is copied onto it.

FIGS. 3 and 4 depict the process of copying encrypted data from the system clipboard and pasting it onto a protected and unprotected destination file, respectively.

### DETAILED DESCRIPTION OF THE INVENTION

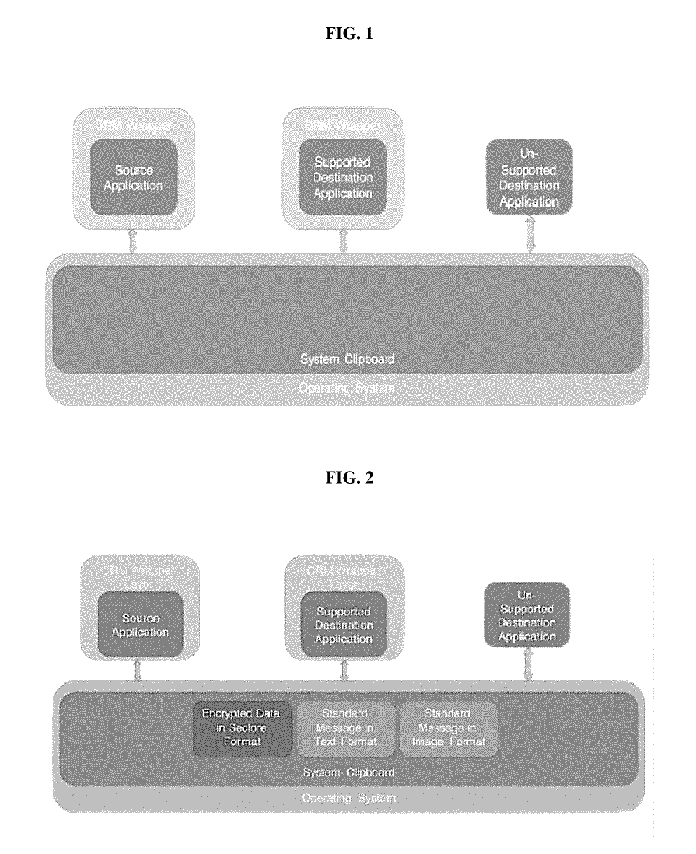

Referring to the Figures generally, and specifically to FIG. 1, the present invention describes a system that allows for the copying of content from a digitally protected source file and pasting of the content into a destination file with an equal or higher level of protection. Thus, once a file is protected through a DRM technology, this system is automatically applied to the file. When such a secured file, (i.e., a file protected by DRM), is accessed, the DRM intercepts system calls such as “copy” or “print,” (i.e., any attempts made by the application to access the system clipboard are intercepted), disallowing copying of secure data. But in some instances, it is necessary for the secured data to be copied from one file into another. The present invention provides for a means of doing the aforementioned.

When a user selects some content from the source file and copies it, it is temporarily pasted onto the system clipboard. It remains on the clipboard for the interim period between copying of data from source file to pasting of data in the destination file. Generally, when data is copied onto the system clipboard, it is copied in a standard format (such as text, rich text, image, etc), or it may be copied in a special format that is recognized only by a particular application(s). For example, NOTEPAD will be unable to recognize format copied from MICROSOFT WORD. Thus, when data is to be stored on the system clipboard, it is important that both format and content information are stored. Alternatively, in order to save memory; system clipboard allows applications to store information in the clipboard without actually copying the content—instead a “placeholder” is put in place of the actual content. This feature of the system clipboard is known as delayed rendering and is achieved by copying NULL data or copying COM object implementing IDataObject interface. When some other application requests for this information, the system generates an event for the source application (from which the data was copied to the clipboard) to collect the data from the source file.

In instances, wherein the actual data itself is copied onto the clipboard, it must be encrypted before being copied. This data is copied in a format known only to the controlling technology, i.e., the DRM technology under use. This encrypted data contains both the format as well as the content information. Simultaneously, the enwrapping feature of the DRM technology, i.e., the DRM encryption layer also copies a second, standard set of content onto the system clipboard, in a standard text and image format (e.g., see FIG. 2). This second set of content has a message stating “The data copied to this system clipboard is protected. You do not have the required permissions to access it.” Depending on the level of security of the destination file, there will be one of two outcomes:

If the destination file is of equal or higher security than the source file, the actual data which was copied from the source file will be pasted; and/or

If the destination file has a lower level of security than the source file, the aforementioned standard message will be pasted.

In general, the level of security of a document compared to another can be understood as follows:

when a user can perform more activities on the content in a file A, file A has lower level of security than a file B in which the user can perform fewer activities on the same content. In short, the security levels are enhanced by restricting the pool of users accessing the file as desired or by curtailing the editorial rights of the users over the shared file thereby achieving higher levels of security.

In the first scenario, the DRM technology ensures that the content is protected, by enforcing the permissions of the destination file.

Once the data has been copied form the source file onto the system clipboard, it must next be pasted into the destination file. During this process of pasting of data, there are two alternatives followed, depending on the manner in which the data was pasted onto the clipboard:

If the original data itself was pasted, it will be present on the clipboard in an encrypted format. Thus, before being pasted into the destination file, the data is decrypted and then pasted; and/or

If a placeholder was pasted instead of the actual data, then the destination application generates a system event for the source application to collect the data from the source file and relay it to the destination file.

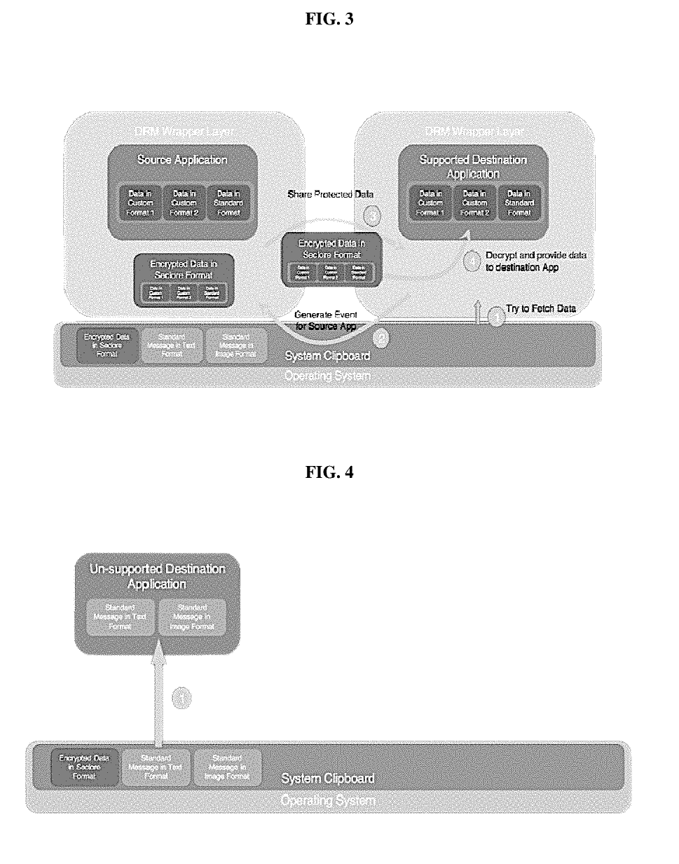

Before the data is pasted into the destination file, the first step that is undertaken by the system is the comparison of the permissions of the source file and the destination file—if these permissions are the same or more constraining for the destination file, then the actual data copied from the source file is decrypted and pasted into the destination file (e.g., see FIG. 3).

Even if an application that is not protected under the DRM technology tries to access the data on the clipboard, it will not be able to, since the data has been encrypted and pasted in a format recognized only by the applications falling under the DRM technology. In such a scenario, the standard message stating “The data copied to this system clipboard is protected. You do not have the required permissions to access it” gets pasted in place of the actual data (e.g., see FIG. 4).

The technical advancements of the system and method envisaged by the present disclosure include that:

This system meets the business needs of transferring data from one protected file to another, without compromising the security of the data.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY and TREO devices), multimedia Internet enabled cellular telephones (e.g., the BLACKBERRY STORM, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

The disclosure has been described with reference to the accompanying embodiments which do not limit the scope and ambit of the disclosure. The description provided is purely by way of example and illustration.

The embodiments herein above and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of files, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification, specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A computer implemented system that allows copying of content from a digitally secured source file and pasting it in a destination file without compromising security of the content, comprising:
a user device having a digital rights management technology installed on it.

2. The system according to claim 1, wherein the user need not install any software, other than the digital rights management technology.

3. A method wherein digital rights management technology allows for transfer of content from a protected source file into a destination file that has the same or higher level of security than the source file, such that the security of the content is not compromised, comprising the steps of:
encrypting a desired content to be copied by the user and pasting it onto a system clipboard in a custom format recognised only by certain applications, the content will remain on the clipboard until a system call to paste the content into the destination file is generated;
copying a standard error message to the system clipboard simultaneous to copying the content from the source file;
comparing levels of protection enforced upon source and destination applications;
pasting the content copied on the clipboard into the destination file if the security of the destination file is found to be more or equal to that of the source file upon comparison; and
displaying a standard message in case the security of the destination file is less than that of the source file.
